(19) United States
(12) Patent Application Publication
(10) Pub. No.: US 2017/0297581 A1
(43) Pub. Date: Oct. 19, 2017

(54) SYSTEM AND METHOD FOR CONTROLLING OPERATION OF MACHINE

(71) Applicant: Caterpillar Inc., Peoria, IL (US)

(72) Inventors: Michael Hatfield, Morton, IL (US); Timothy M. Crane, Peoria, IL (US)

(73) Assignee: Caterpillar Inc., Peoria, IL (US)

(21) Appl. No.: 15/132,314

(22) Filed: Apr. 19, 2016

(51) Int. Cl. B60W 40/08; B60Q 9/00; G05B 9/02; G05D 1/00

(52) U.S. Cl. CPC B60W 40/08; G05B 9/02; G05D 1/0088; B60Q 9/008; B60W 2040/0827; B60W 2420/42; B60W 2550/10

(57) ABSTRACT

The present disclosure relates to system for controlling operation of machine. The system includes fatigue detection unit configured to generate a signal indicative of fatigue parameter of an operator of the machine. The system includes proximity sensing unit to capture image of a surrounding area of the machine. The system further includes a controller, configured to determine fatigue condition of the operator and to detect presence of an obstacle in the surrounding area of the machine. The controller is further configured to generate a warning signal based on the fatigue condition of the operator and the captured image of the surrounding area of the machine. The controller is configured to communicate signal indicative of the action of the operator with a control module of the machine. The control module autonomously control operation of the machine based on a signal indicative of the action of the operator.

### TECHNICAL FIELD

The present disclosure generally relates to controlling an operation of a machine, and more particularly relates to a system and a method for controlling the operation of the machine based on fatigue condition of an operator and surrounding area of the machine.

### BACKGROUND

Mining operations are carried out for continuous long hours in a harsh environment at mining sites. Machines, such as, dump vehicles, and mining excavators are operated by operators round the clock. The operators operating the machines are also kept working for long hours. The operators are more likely to undergo fatigue due to long and rigorous working hours. For purposes of this disclosure, “fatigue” refers to drowsiness, tiredness, weariness, exhaustion, weakness, or a general decrease in awareness or alertness. The operator fatigue is often a contributory factor in accidents. The operators who are under fatigue and restlessness are vulnerable to the fatigue effect and they need to be kept-off from the operations in order to maintain their safety and health. Fatigue may delay response of the operators to external conditions and thus may cause a safety threat and may reduce productivity. Furthermore, fatigue can be an early sign that the operators may fall asleep while operating the machines. Sometimes, the operators experiencing fatigue may be unaware of the fatigue that they are experiencing. Also, due to fatigue, the operators often may not be aware that they have fallen asleep for short periods of time while operating the machines. Thus, determining the fatigue of the operators during the working hours may be considered as a key factor for a healthy work environment at the worksite and for maintaining safety of the operators. There exists a variety of systems to determine the fatigue of operators. However, the systems may not be able to prevent unintended operations that may be carried out by the operators at the worksite due to fatigue.

One such known system includes incorporating an autonomous machine control operation in vehicles. Typically, a highway vehicle includes an autonomous controlling operation, such as braking of the machine, if any obstacle is present on the way. However, the system is focused solely on an external environment to the vehicle.

U.S. Pat. No. 8,874,301, hereinafter referred to as the '301 patent, discloses a transportation vehicle with an autonomous driving control. The transportation vehicle with an autonomous driving control has a set-up mode, an active drive mode, a safe shutdown mode, and an emergency response mode. The active drive mode autonomously navigates along a driving route specified in the set-up mode. A driver sensing system senses a driver's presence in the driver seat and a driver's physiological state. While in active driving mode, an elapsed time period is measured whenever the driver's presence is not detected. If the time period increases above a first threshold then a notice is given to the driver that the active drive mode may be interrupted. If the time period increases above a second threshold then the active drive mode is terminated and the safe shutdown mode is initiated. A sensed physiological state is compared with a predetermined emergency condition and if a match is found, then the autonomous driving control terminates the active drive mode and the emergency response mode is initiated.

### SUMMARY OF THE DISCLOSURE

In one aspect of the present disclosure, a system for controlling operation of a machine is provided. The system includes a fatigue detection unit disposed in the machine. The fatigue detection unit is configured to generate a signal indicative of at least one fatigue parameter of an operator of the machine. The system further includes a proximity sensing unit disposed in the machine. The proximity sensing unit is configured to capture image of a surrounding area of the machine. The system further includes a controller communicatively coupled to the fatigue detection unit and the proximity sensing unit. The controller is configured to determine a fatigue condition of the operator based on the signal indicative of the at least one fatigue parameter received from the fatigue detection unit. The controller is further configured to detect presence of an obstacle in the surrounding area of the machine based on the captured image of the surrounding area of the machine. The controller is further configured to generate a warning signal based on the fatigue condition of the operator and the captured image of the surrounding area of the machine. The controller is further configured to monitor action of the operator in response to the generated warning signal. The controller is further configured to communicate a signal indicative of the action of the operator with a control module of the machine. The control module is configured to autonomously control operation of the machine based on the signal indicative of the action of the operator.

In another aspect of the present disclosure, a method of controlling operation of the machine is provided. The method includes determining a fatigue condition of an operator based on a signal indicative of at least one fatigue parameter received from a fatigue detection unit, via a controller. The method further includes detecting a presence of an obstacle in a surrounding area of the machine based on a captured image of the surrounding area of the machine, via a proximity sensing unit. The method further includes generating a warning signal based on the fatigue condition of the operator and the captured image of the surrounding area of the machine, via the controller. The method further includes monitoring an action of the operator in response to the generated warning signal. The method further includes communicating a signal indicative of the action of the operator with a control module of the machine for autonomously controlling operation of the machine based on the signal indicative of the action of the operator.

In yet another aspect of the present disclosure, a machine is provided. The machine includes a frame and an operator cabin mounted on the frame. The machine further includes a fatigue detection unit disposed within the operator cabin of the machine. The fatigue detection unit is configured to generate a signal indicative of at least one fatigue parameter of an operator of the machine. The machine further includes a proximity sensing unit disposed in the machine. The proximity sensing unit is configured to capture an image of a surrounding area of the machine. The machine further includes a controller communicatively coupled to the fatigue detection unit and the proximity sensing unit. The controller is configured to determine a fatigue condition of the operator based on the signal indicative of the at least one fatigue parameter received from the fatigue detection unit. The controller is further configured to detect a presence of an obstacle in the surrounding area of the machine based on the captured image of the surrounding area of the machine. The controller is further configured to generate a warning signal based on the fatigue condition of the operator and the captured image of the surrounding area of the machine. The controller is further configured to monitor action of the operator in response to the generated warning signal. The controller is further configured to communicate a signal indicative of the action of the operator with a control module of the machine. The control module is configured to autonomously control operation of the machine based on the signal indicative of the action of the operator.

Other features and aspects of this disclosure will be apparent from the following description and the accompanying drawings.

### BRIEF DESCRIPTION OF THE DRAWINGS

FIG. 1 is a side view of a machine including a system for controlling operation of the machine, according to an embodiment of the present disclosure;

FIG. 2 is a magnified view of an operator cabin of the machine including a fatigue detection unit, according to an embodiment of the present disclosure;

FIG. 3 is a schematic block diagram of the system for controlling operation of the machine, according to an embodiment of the present disclosure;

FIG. 4 is a perspective view of the machine at a worksite hauling from a mining site to a dumping site, according to an exemplary embodiment of the present disclosure;

FIG. 5 is a side view of the machine showing dumping of an aggregate material at the dumping site, according to an exemplary embodiment of the present disclosure;

FIG. 6 is a flowchart of a method for controlling an operation of the machine, according to an embodiment of the present disclosure; and

FIG. 7 shows a flowchart of a method of controlling an operation of the machine, according to another embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

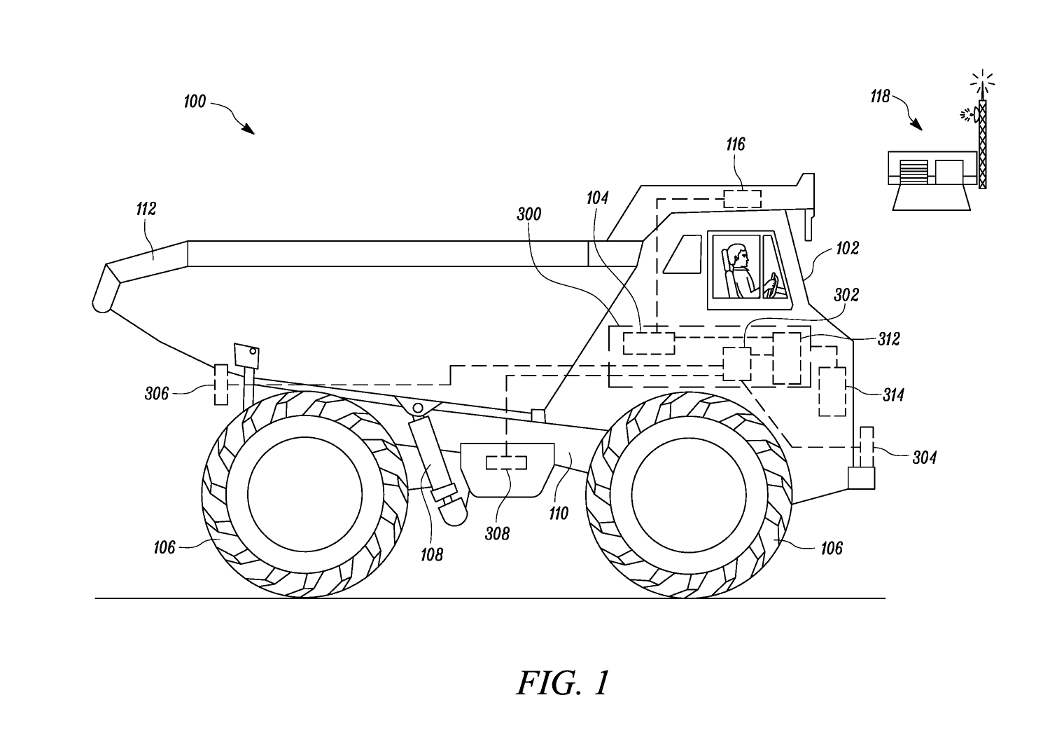

FIG. 1 illustrates a side view of a machine 100, in which embodiments of the present disclosure may be implemented. In the illustrated example, the machine 100 is a large mining truck, also known as haul truck. It should be noted that the machine 100 may alternatively be any other machine, including, but not limited to, an articulated truck, an on-road vehicle, an off-road vehicle or any other machine capable of transporting material from one location to another location. In another embodiment, the machine 100 may be any one of a wheel loader, a track type tractor, an elevated sprocket tractor machine, an excavator, motor grader, a cold planar machine, a roof bolter, a paving machine, a pneumatic compactor, a wheel tractor scraper. The machine 100 may include one or more implements coupled to a frame 110 of the machine 100. The one or more implements may include a bucket, a fork arrangement, a blade, a shovel, a ripper, a dump bed, a broom, a snow blower, a propelling device, a cutting device, a grasping device, or any other task-performing device known in the art. The one or more implements may be connected to the machine 100 by a pivot member, a linkage system, and one or more hydraulic cylinders. The one or more implements may be configured to pivot, rotate, slide, swing, lift, or move relative to the frame 110 of the machine 100 in any manner known in the art. The machine 100 may be configured to perform operations, including, but not limited to, mining, forestry, waste management, construction and quarry, transportation, logistics, agriculture or any other tasks known in the art.

A powertrain (not shown) may be provided in the machine 100, which may include one or more power sources. The power source may be one or a combination of an internal combustion engine, a gas turbine, a hybrid engine, a non-conventional power source like batteries, electric motor, or any other power sources known in the art. The powertrain may further include a transmission unit inclusive of gears, drive shafts, propeller shaft and other known drive links provided for transferring of power from the power source to a set of ground engaging members 106. The ground engaging members 106, such as wheels, are provided to the machine 100 for the purpose of mobility. In an alternative embodiment, the ground engaging members 106 may include tracks.

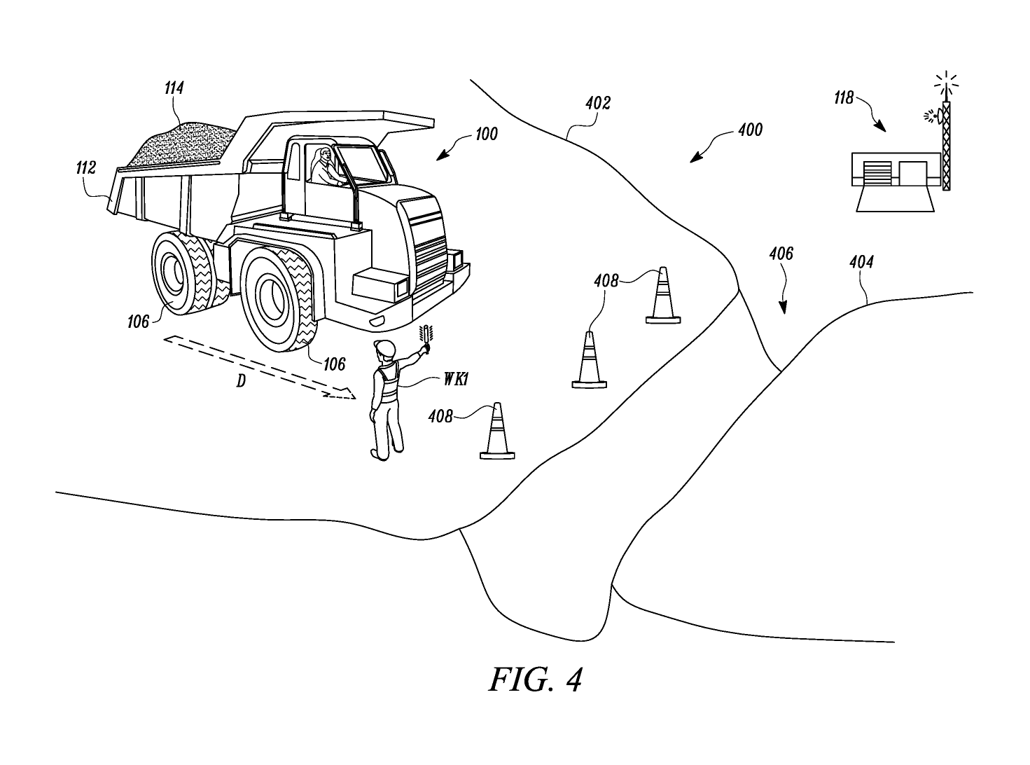

Referring to FIG. 1, a dump body 112 is pivotally mounted on the frame 110 of the machine 100. In one example, hydraulic and/or pneumatic cylinders 108 may be mounted on the frame 110 and connected to the dump body 112 to enable movement of the dump body 112 with respect to the frame 110. In other example, the dump body 112 may be of ejector type, side dump type, or bottom dump type, that are well known in the art. The dump body 112 may be constructed to perform an intended task of transportation of payload and dumping of the payload. The dump body 112 may receive, transport and dump the payload from a source such as a loading site (not shown) to a dumping site 404 (shown in FIG. 4), such as, a processing facility or a shipping facility. The payload may include construction material and/or other material like, sand, gravel, stones, rocks, soil, excavated material, asphalt, coal, mineral ores, and the like. The dump body 112 of the machine 100 may be controlled by a system 300 disposed in the machine 100.

The system 300 controls an operation of the machine 100. The system 300 includes a fatigue detection unit 104 disposed within an operator cabin 102. The operator cabin 102 is disposed on the frame 110 of the machine 100. In an example, the fatigue detection unit 104 is configured to generate a signal indicative of a fatigue parameter of an operator of the machine 100. The operator cabin 102 may also house various control devices for controlling operation of the machine 100, and a camera unit 116. The camera unit 116 is configured to communicatively couple with the fatigue detection unit 104. The system 300 further includes a proximity sensing unit 302, and a controller 312 in communication with the fatigue detection unit 104 and the proximity sensing unit 302. The proximity sensing unit 302 includes a front image capturing device 304, a rear image capturing device 306, a right side image capturing device 308 and a left side image capturing device 310 (not shown). The front image capturing device 304, the rear image capturing device 306, the right side image capturing device 308 and the left side image capturing device 310 are configured to capture an image of a surrounding area of the machine 100. It is contemplated that locations of the front, rear, right side and left side image capturing devices 304, 306, 308, and 310 may be varied depending on specification of the machine 100 and feasibility of the location on the machine 100. It should be understood that the location of the front, rear, right side and left side image capturing devices 304, 306, 308, 310 may be made to capture the image of the surrounding area of the machine 100. The machine 100 further includes a control module 314, which is configured to determine operating parameters of the machine 100, including, but not limited to, an engine condition, ground speed of the machine 100, and distance traveled or any other parameter known in the art. The control module 314 as referred herein may be an Electronic Control Module (ECM). The control module 314 is in communication with the controller 312 of the system 300 and a remote station 118.

The operator of the machine 100 may receive remote assistance from a supervisor located at the remote station 118. In an alternate embodiment, the machine 100 may be controlled by the supervisor located in the remote station 118 remotely. Remote monitoring may be performed through a wireless communication known in the art. In an embodiment, the machine 100 may be tracked using a positioning system including, but not limited to, Global Positioning System (GPS), Global Navigation Satellite System (GNSS), and trilateration/triangulation of cellular networks or Wi-Fi networks.

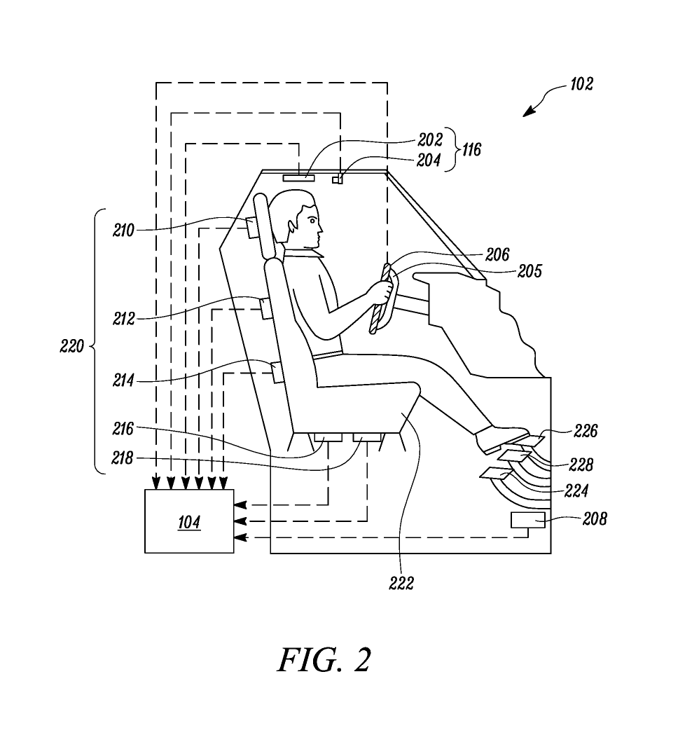

FIG. 2 illustrates a magnified view of the operator cabin 102 of the machine 100. In one embodiment, the operator cabin 102 houses the fatigue detection unit 104. In an alternative embodiment, the fatigue detection unit 104 may be disposed at any location on the frame 110 of the machine 100 and outside the operator cabin 102. The fatigue detection unit 104 includes the camera unit 116 and a plurality of sensors 220.

In an embodiment, the camera unit 116 may be disposed at an inner surface of a roof of the operator cabin 102. The camera unit 116 further includes a first camera 202 and a second camera 204. The first camera 202 is configured to capture an image of head position of the operator and generate a signal indicative of head movement of the operator. The generated signal indicative of the head movement of the operator is communicated to the fatigue detection unit 104. The second camera 204 is configured to capture an image of face of the operator and generate a signal indicative of number of eye blinks of the operator. The generated signal indicative of the number of eye blinks of the operator is communicated to the fatigue detection unit 104. It is contemplated that the camera unit 116 may be replaced with any other image capturing device to serve a purpose of capturing image of the head position and the face of the operator. The camera unit 116 may be disposed at any other location inside the operator cabin 102. In an embodiment, the camera unit 116 may be disposed at a rear-view mirror of the machine 100. In another embodiment, the camera unit 116 may be disposed outside the operator cabin 102, may be, at side-view mirrors located outside the operator cabin 102. The plurality of sensors 220 includes a steering wheel sensor 206, a pedal sensor 208, a head rest sensor 210, a first backrest sensor 212, a second backrest sensor 214, a first seat sensor 216 and a second seat sensor 218. The steering wheel sensor 206 is configured in a steering wheel 205 of the machine 100, and configured to detect movement and pressure of hand of the operator on the steering wheel 205. A signal indicative of the movement and the pressure of the hand of the operator on the steering wheel 205 is communicated to the fatigue detection unit 104. The pedal sensor 208 is positioned proximal to pedals, may be, an accelerator pedal 224, a brake pedal 228 and a clutch pedal 226. The pedal sensor 208 is configured to detect a foot movement of the operator on the accelerator pedal 224, the brake pedal 228 and the clutch pedal 226. The pedal sensor 208 generates a signal indicative of the foot movement of the operator on the accelerator pedal 224, the brake pedal 228 and the clutch pedal 226. The generated signal indicative of the foot movement of the operator on the accelerator pedal 224, the brake pedal 228 and the clutch pedal 226 is communicated to the fatigue detection unit 104.

Further, the head rest sensor 210, the first backrest sensor 212, the second backrest sensor 214, the first seat sensor 216 and the second seat sensor 218 are disposed at an operator seat 222. The head rest sensor 210 is configured to detect a position of head of the operator and generate a signal indicative of the position of the head of the operator. The generated signal indicative of the position of the head of the operator is communicated to the fatigue detection unit 104. The first backrest sensor 212 and the second backrest sensor 214 are configured to detect a position of back portion of the operator and generate a signal indicative of the position of the back portion of the operator. The generated signal indicative of the position of the back portion of the operator is communicated to the fatigue detection unit 104. The first seat sensor 216 and the second seat sensor 218 are configured to detect a position of the operator on the operator seat 222 and generate a signal indicative of the position of the operator on the operator seat 222. The generated signal indicative of the position of the operator is communicated to the fatigue detection unit 104. It is contemplated that the operator cabin 102 may be included with number of various other sensors to serve the purpose of obtaining physiological characteristics of the operator. For example, heart beats, sitting posture with respect to the steering wheel 205 and movement of head, hands and legs.

In an embodiment, the controller 312 compares the determined position of the head of the operator with a threshold head position, compares the determined position of the back of the operator with a threshold position of the back, compares the determined position of the operator on the operator seat 222 with a threshold position of the operator, and compares the determined position of the foot with a threshold position of the foot of the operator. The “threshold position” as used herein, is a position of the operator at which the operator is determined to be in alert condition.

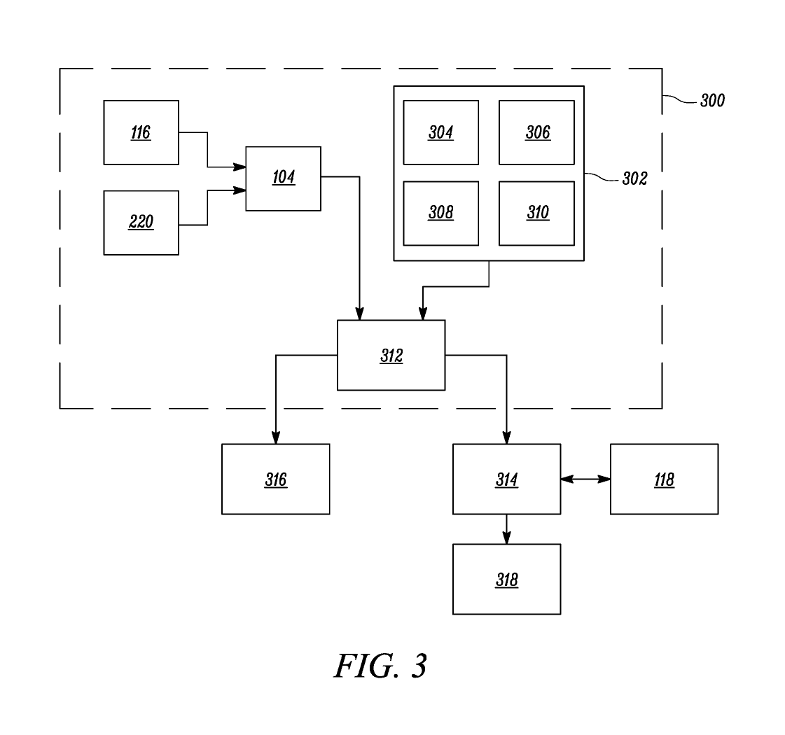

FIG. 3 illustrates a block diagram of the system 300 included in the machine 100 for controlling the operation of the machine 100, according to an embodiment of the present disclosure. The system 300 includes the fatigue detection unit 104, the proximity sensing unit 302, and the controller 312. The fatigue detection unit 104 includes the camera unit 116 and the plurality of sensors 220. The plurality of sensors 220 includes the steering wheel sensor 206, the pedal sensor 208, the head rest sensor 210, the first backrest sensor 212, the second backrest sensor 214, the first seat sensor 216 and the second seat sensor 218. The fatigue detection unit 104 is configured to determine the fatigue parameter of the operator based on the signals received from the camera unit 116 and the plurality of sensors 220. A signal indicative of the fatigue parameter is communicated to the controller 312 of the system 300.

The controller 312 of the system 300 is configured to determine a fatigue condition of the operator based on the signal indicative of the fatigue parameter received from the fatigue detection unit 104. In one embodiment, the controller 312 is configured to compare the fatigue parameter with a threshold range, and configured to determine the fatigue condition of the operator based on the comparison of the fatigue parameter with the threshold range. For example, if the number of eye blinks of the operator is detected to be outside the threshold range, i.e., less than 20 blinks per minute or more than 45 blinks per minute, then the operator may be determined to be in a fatigue condition. In another embodiment, the controller 312 is further configured to compare the fatigue parameter with a threshold value, and configured to determine the fatigue condition of the operator based on the comparison of the fatigue parameter with the threshold value. For the purposes of this disclosure, the “threshold value” refers to a maximum value of the fatigue parameter beyond which the operator is determined to be in the fatigue condition. For example, if the head position of the operator is deviated to a distance of about 10 cm from a normal or upright position, then the operator may be determined to be in the fatigue condition.

The controller 312 is further configured to communicate with a warning generation unit 316 for generating a warning signal if the operator is determined to be in the fatigue condition. Based on the warning signal from the warning generation unit 316, the controller 312 monitors an action taken by the operator in response to the generated warning signal. If the operator is determined to be non-responsive to the generated warning signal within a threshold time, the controller 312 of the system 300 communicates a signal to an autonomous control unit 318 of the machine 100 for taking actions in response to the determined fatigue condition of the operator. In the illustrated embodiment, autonomously controlling operation of the machine 100 may include shutting down or switching off an engine of the machine 100.

The proximity sensing unit 302 of the system 300 including the front image capturing device 304, the rear image capturing device 306, the right side image capturing device 308 and the left side image capturing device 310 is provided to capture an image of surrounding area of the machine 100. The front image capturing device 304 is configured to capture an image of surrounding area of the machine 100 at a front end. The rear image capturing device 306 is configured to capture an image of surrounding area of the machine 100 at a rear end. The right side image capturing device 308 and the left side image capturing device 310 are configured to capture image of surrounding areas of the machine 100 at right side and left side, respectively. A signal from each of the front image capturing device 304, the rear image capturing device 306, the right side image capturing device 308 and the left side image capturing device 310 is generated in response to the captured image and is communicated to the controller 312. In an embodiment, the image of the surrounding area may include an obstacle. The term “obstacle” as used herein refers to an object/restriction that may be found in a hauling way or working personnel located at the mining site 402 (shown in FIG. 4) or a dumping site 404 (shown in FIG. 4). It is contemplated that the object may include, but not limited to, other working machines, deep excavations, dugouts, barricades located at the mining site 402 and/or the dumping site 404. If the controller 312 determines the presence of any obstacle in the captured image of the surrounding area within a threshold distance, then the controller 312 communicates to the warning generation unit 316 to generate the warning signal for the operator. In an embodiment, the controller 312 is configured to generate the warning signal only when the obstacle is present in the captured image of the surrounding within the threshold distance. The “threshold distance” as used herein refers to a safe distance at which the autonomous control unit 318 is allowed to take actions on behalf of the operator. In an embodiment, if the operator is taking the action in response to the generated warning signal within the threshold time, the controller 312 is configured to communicate a signal to the warning generation unit 316 to abandon the generation of the warning signal. In another embodiment, if the operator is non-responsive to the generated warning signal in response to the obstacle within the threshold time, then the controller 312 communicates the signal to the control module 314 of the machine 100 to activate the autonomous control unit 318. The autonomous control unit 318 takes action in response to the presence of the obstacle. In the present embodiment, the autonomously controlling operation of the machine 100 includes a terminating operation of the machine 100 or shutting down the engine of the machine 100.

In another embodiment, if the operator is determined to be in the fatigue condition and if the image of the surrounding area include the obstacle within the threshold distance, then the controller 312 generates the warning signal to the operator for taking action in response to the fatigue condition and the obstacle found in the surrounding area. Further, the controller 312 monitors if the operator is taking the action in response to the generated warning signal. If the response time required by the operator for taking action has exceeded the threshold time, then the controller 312 communicates the signal to the control module 314 of the machine 100 to communicate to the autonomous control unit 318 to autonomously control operation of the machine 100. In this embodiment, the autonomously control operation of the machine 100 includes the terminating operation of the machine 100 and shutting down the engine of the machine 100. In an embodiment, the control module 314 of the machine 100 is configured to communicate with the remote station 118 to record data of the fatigue condition and responsiveness of the operator for evaluating efficiency and performance of the operator.

FIG. 4 illustrates a perspective view of the machine 100 at a worksite 400, according to an exemplary embodiment of the present disclosure. The machine 100, for example, is carrying an aggregate material 114 from the mining site 402 to the dumping site 404. After loading of the aggregate material 114 in the dump body 112 of the machine 100 at the worksite 400, the machine 100 is moved in a direction of travel “D” towards the dumping site 404.

In an example, if the operator is determined to be in the fatigue condition and due to which the operator is also found to be in a drowsy condition, the controller 312 of the system 300 instructs the warning generation unit 316 to generate the warning signal based on the fatigue condition of the operator. The warning signal thus generated may induce the operator to take action to avoid undesirable incidents that may be detrimental to the operator and working personnel at the worksite 400.

In another example, the machine 100 is traveling in the direction of travel “D”. The front image capturing device 304 located at the front end of the machine 100 captures the image of the surrounding area of the machine 100 and communicates with the controller 312 of the machine 100. The surrounding area of the machine 100 is determined to be including the obstacle within the threshold distance. The controller 312 communicates to the warning generation unit 316 to generate the warning signal. In the illustrated example, the obstacle is a dugout 406 in the hauling way. As the dugout 406 is located in the hauling way, an area before the dugout 406 is indicated with cone barricades 408. In addition to the cone barricades 408, a worker WK1 is also present to indicate the obstacle in the worksite 400. The cone barricades 408 present in front of the obstacle indicates that the machine 100 traveling through the hauling way in the direction of travel “D” needs an attention and refrain traveling due to the presence of the obstacle. If the operator of the machine 100 is non-responsive to the warning signal within the threshold time, the controller 312 of the system 300 communicates to the control module 314 to instruct the autonomous control unit 318 for autonomously controlling operation of the machine 100. In this embodiment, the autonomously controlling operation of the machine 100 includes shutting down the engine of the machine 100. In an embodiment, the control module 314 of the machine 100 is configured to communicate with the remote station 118 to record data of the fatigue condition and responsiveness of the operator for evaluating efficiency and performance of the operator.

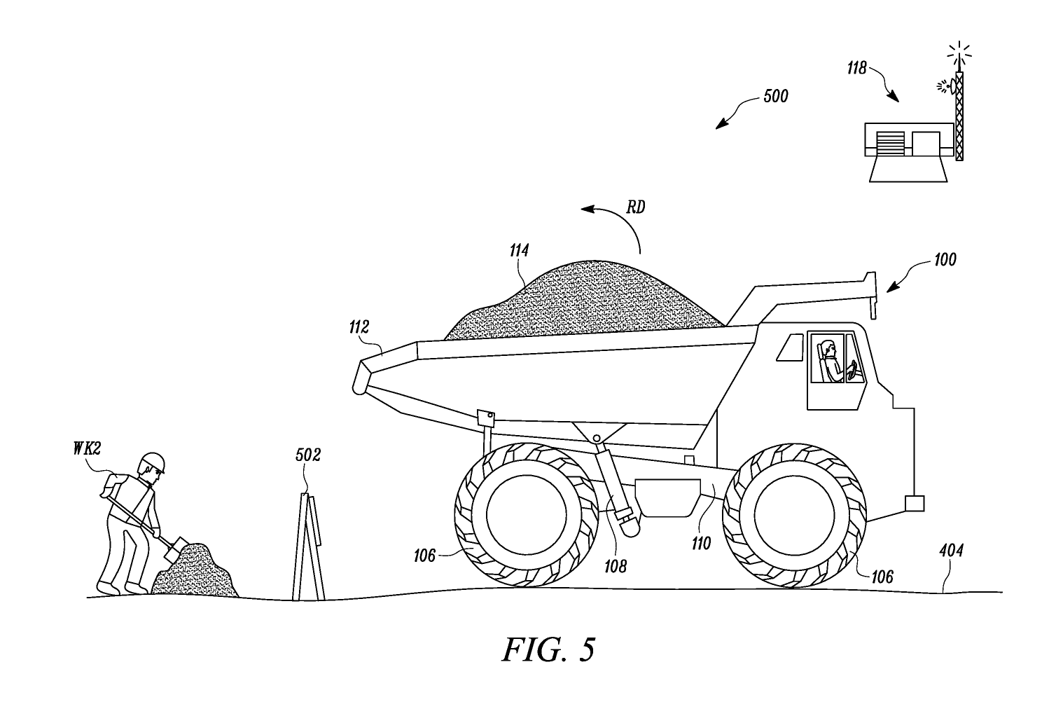

FIG. 5 illustrates a side view of the machine 100 showing dumping of the aggregate material 114 at the dumping site 404, according to an exemplary embodiment of the present disclosure. The machine 100, in the illustrated example, is loaded with the aggregate material 114 and is in the operation of dumping or unloading the aggregate material 114 at the dumping site 404.

In an example, if the operator is determined to be in the fatigue condition and due to which the operator is also found to be in a drowsy condition, the controller 312 of the system 300 instructs the warning generation unit 316 to generate the warning signal based on the fatigue condition of the operator. The warning signal thus generated may induce the operator to take action to avoid undesirable incidents that may be detrimental to the operator and working personnel at the worksite 500.

In another example, the machine 100 is in a stationary condition at the worksite 500 and the operator is operating the machine 100 for dumping the aggregate material 114 by activating the hydraulic cylinders 108 by rotating the dump body 112 in a direction of rotation “RD”. The rear image capturing device 306 located at the rear end of the machine 100 captures the image of the surrounding area of the machine 100 and communicates with the controller 312 of the machine 100. As the surrounding area of the machine 100 is determined to be including the obstacle, the controller 312 communicates with the warning generation unit 316 to generate the warning signal. In the illustrated example, the obstacle is determined to be a worker “WK2” working at the dumping site 404. As the obstacle is present at the dumping site 404, the area before the obstacle is indicated with a horizontal barricade 502. The horizontal barricade 502 present in front of the obstacle indicates that the operator of the machine 100 need not carry out the dumping operation at the dumping site 404 as the dumping site 404 includes the obstacle. If the operator of the machine 100 intends to dump the aggregate material 114 even after the generation of the warning signal due to presence of the obstacle, the controller 312 of the system 300 communicates to the control module 314 to instruct the autonomous control unit 318 for autonomously controlling the operation of the machine 100. In this embodiment, the autonomously controlling operation of the machine 100 includes terminating the dumping operation. In an embodiment, the control module 314 of the machine 100 is configured to communicate with the remote station 118 to record data of the fatigue condition and responsiveness of the operator for evaluating efficiency and performance of the operator.

### INDUSTRIAL APPLICABILITY

The system 300 includes the fatigue detection unit 104, and the proximity sensing unit 302 to send the signals indicative of the fatigue condition of the operator and the image of the surrounding area of the machine 100, respectively, to the controller 312. The fatigue detection unit 104 includes the camera unit 116 and the plurality of sensors 220 to receive signals indicative of the fatigue parameters associated with the fatigue condition of the operator. The head rest sensor 210 communicates with the fatigue detection unit 104 to determine the position of the head of the operator. The first and second back rest sensors 212, 214 communicate with the fatigue detection unit 104 to determine the position of the back of the operator. The first and second seat sensors 216, 218 communicate with the fatigue detection unit 104 to determine the position of operator on the operator seat 222. The pedal sensor 208 communicates with the fatigue detection unit 104 to determine the position of the foot of the operator.

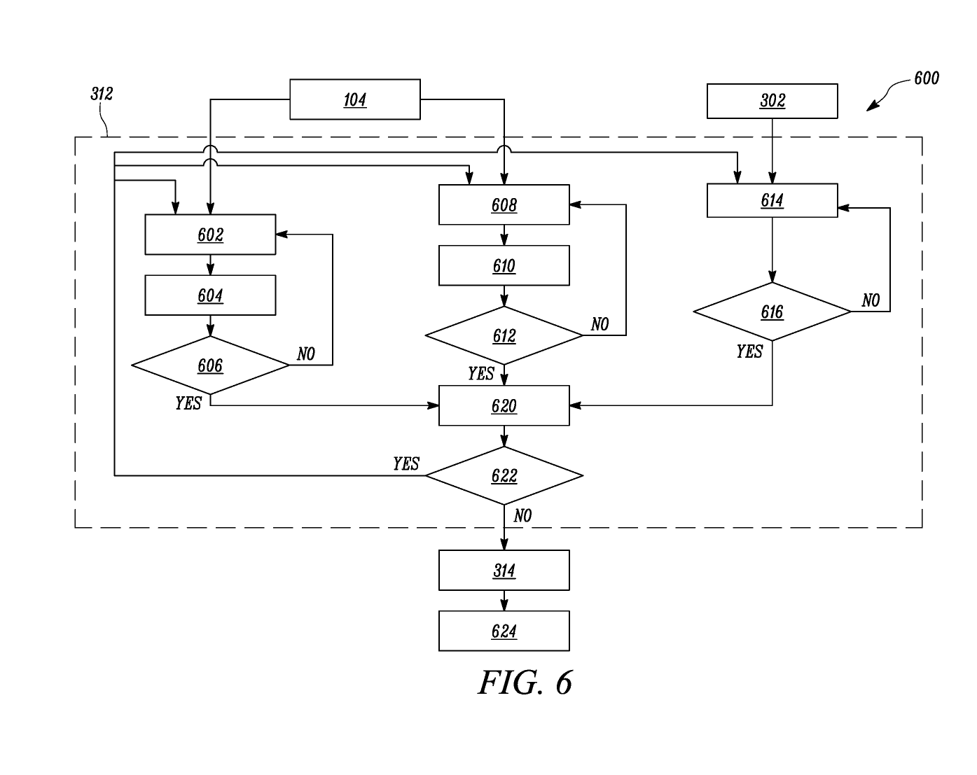

FIG. 6 shows a flowchart of a method 600 for controlling the operation of the machine 100, according to an embodiment of the present disclosure. At block 602, the controller 312 receives the signal indicative of the position of the head, position of the back, position of the foot of the operator and position of the operator on the operator seat 222. At block 604, the controller 312 compares at least one of the fatigue parameters with the threshold range. In the exemplary embodiment, the controller 312 compares the determined position of the head of the operator with a threshold head position, compares the determined position of the back of the operator with a threshold position of the back, compares the determined position of the operator on the operator seat 222 with a threshold position of the operator, and compares the determined position of the foot with a threshold position of the foot of the operator. At block 606, the controller 312 identifies if the determined position of the head is exceeding the threshold head position, if the determined position of the back of the operator is exceeding the threshold position of the back, if the determined position of operator on the operator seat 222 is exceeding the threshold position of the operator, and if the determined position of the foot is exceeding the threshold position of the foot. If any one of the fatigue parameters exceeds the threshold position, then the controller 312 indicates that the operator is undergoing fatigue and generates the signal indicative of the fatigue condition of the operator. At block 620, the controller 312 communicates the signal to the warning generation unit 316 to generate the warning signal to alert the operator.

At block 606, if any one of the fatigue parameters is not exceeding the threshold value, then the controller 312 determines that the operator is in active state or alert state and may not be undergoing fatigue. The controller 312 keeps checking further to determine if the operator is experiencing the fatigue.

Further, at block 608, the fatigue detection unit 104 receives the details of number of eye blinks of the operator in a predetermined time. Thereafter, the fatigue detection unit 104 compares the number of eye blinks of the operator with the threshold range of blinks at block 610. At block 612, the fatigue detection unit 104 determines that if the number of eye blinks of the operator is exceeding the threshold range of blinks. If the number of eye blinks of the operator is exceeding the threshold range of blink, then the fatigue detection unit 104 ascertains that the operator is experiencing fatigue and generates the signal indicative of the fatigue condition of the operator. The generated signal is communicated to the warning generation unit 316 to generate the warning signal to the operator at block 620.

At block 606, the fatigue detection unit 104 determines that the number of eye blinks of the operator is not exceeding the threshold range of blinks. Thus, the fatigue detection unit 104 ascertains that the operator is not experiencing any fatigue. The controller 312 keeps checking further to determine if the operator is experiencing the fatigue.

Further, the proximity sensing unit 302 including the front image capturing device 304, the rear image capturing device 306, the right side image capturing device 308 and the left side image capturing device 310 captures the image of the surrounding area of the machine 100 at block 614. The captured image of the surrounding area of the machine 100 is communicated to the controller 312 of the system 300. The controller 312 determines if the captured image of the surrounding area is including any obstacle within the threshold distance, at block 616. If the captured image of the surrounding area is determined to be including the obstacle within the threshold distance, then the controller 312 communicates with the warning generation unit 316 to generate the warning signal at block 620.

At block 620, the warning signal is generated by the warning generation unit 316 based on the fatigue condition of the operator or presence of the obstacle within the threshold distance in the captured image. The controller 312 determines if the operator is taking action in response to the generated warning signal at block 622. If the controller 312 determines that the operator is non-responsive to the warning signal, then the controller 312 instructs the control module 314 of the machine 100 to activate the autonomous control unit 318 to autonomously control the operation of the machine 100 based on requirement, at block 624. In an embodiment, the autonomously controlling operation of the machine 100 includes anyone of the terminating operation of the machine 100 or shutting down the engine of the machine 100.

At block 622, if the operator is taking action in response to the generated warning signal, then the controller 312 determines that the operator is in active state or alert state and may not be undergoing fatigue. The controller 312 keeps checking further to determine if the operator is experiencing the fatigue.

Further at block 622, if the operator is taking action in response to the generated warning signal, then the controller 312 determines that the number of eye blinks of the operator is not exceeding the threshold range of blinks. Thus, the fatigue detection unit 104 ascertains that the operator is not experiencing any fatigue. The controller 312 keeps checking further to determine if the operator is experiencing the fatigue.

Further at block 622, if the operator is taking action in response to the generated warning signal, then the controller 312 determines that the obstacle in the surrounding area is not within the threshold distance. Thus, the controller 312 keeps checking to determine if the obstacle is within the threshold distance.

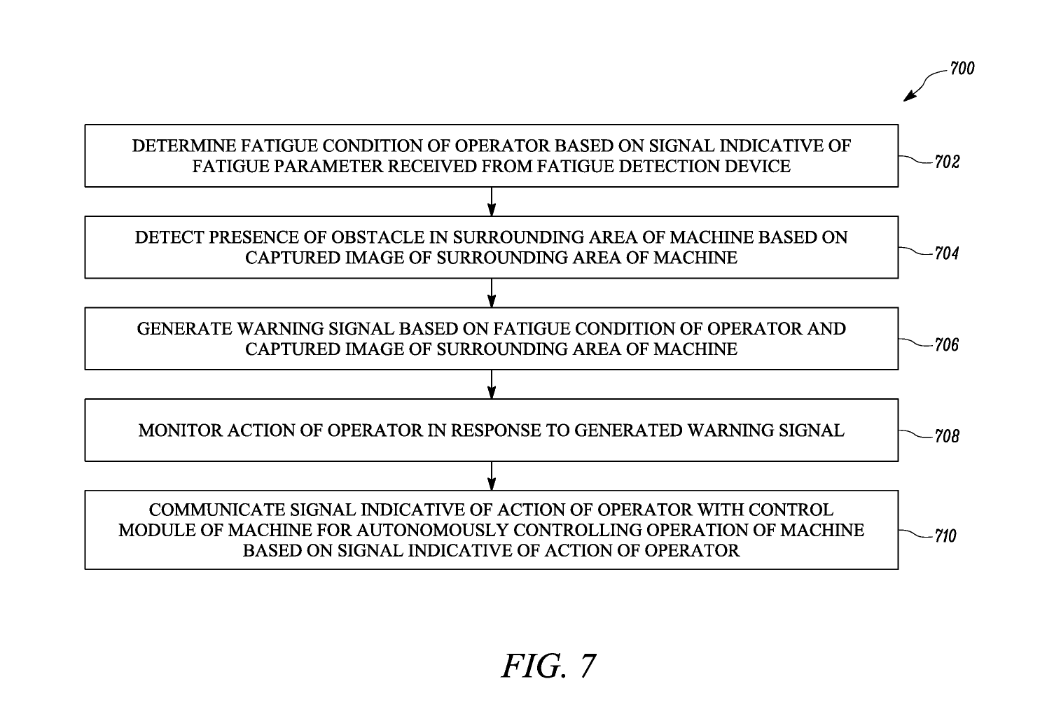

FIG. 7 illustrates a flowchart of a method 700 of controlling operation of the machine 100, according to another embodiment of the present disclosure. The method 700 includes determining the fatigue condition of the operator based on the signal indicative of at least one fatigue parameter received from the fatigue detection unit 104, via the controller 312, at a step 702. At a step 704, the proximity sensing unit 302 detects presence of the obstacle in the surrounding area of the machine 100 based on the captured image of the surrounding area of the machine 100. At a step 706, the controller 312 generates the warning signal based on the fatigue condition of the operator and the captured image of the surrounding area of the machine 100. After generating the warning signal, the controller 312 monitors the action of the operator in response to the generated warning signal at a step 708. At a step 710, the controller 312 communicates the signal indicative of the action of the operator with the control module 314 of the machine 100 for autonomously controlling operation of the machine 100 based on the signal indicative of the action of the operator.

The method 700 further includes communicating with the remote station 118 for validating the fatigue condition of the operator via the controller 312. The at least one fatigue parameter of the operator is selected from eye blinks, heart beats, sitting posture with respect to the steering wheel 205 and movement of head, hands and legs. The method 700 further includes comparing the at least one fatigue parameter with the threshold range, and determining the fatigue condition of the operator based on the comparison of the at least one fatigue parameter with the threshold range.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for controlling operation of a machine, the system comprising:
a fatigue detection unit disposed in the machine, the fatigue detection unit configured to generate a signal indicative of at least one fatigue parameter of an operator of the machine;
a proximity sensing unit disposed in the machine, the proximity sensing unit configured to capture image of a surrounding area of the machine; and
a controller communicatively coupled to the fatigue detection unit and the proximity sensing unit, the controller configured to:
determine a fatigue condition of the operator based on the signal indicative of the at least one fatigue parameter received from the fatigue detection unit;
detect a presence of an obstacle in the surrounding area of the machine based on the captured image of the surrounding area of the machine;
generate a warning signal based on the fatigue condition of the operator and the captured image of the surrounding area of the machine;
monitor action of the operator in response to the generated warning signal; and
communicate a signal indicative of the action of the operator with a control module of the machine, the control module configured to autonomously control operation of the machine based on a signal indicative of the action of the operator.

2. The system of claim 1, wherein the fatigue detection unit comprises a camera unit and a plurality of sensors disposed within an operator cabin of the machine.

3. The system of claim 1, wherein the proximity sensing unit comprises a front image capturing device and a rear image capturing device.

4. The system of claim 1, wherein the autonomous control operation of the machine comprises at least one of terminating operation of the machine and shutting down an engine of the machine.

5. The system of claim 1, wherein the controller is configured to communicate with a remote station for validating the fatigue condition of the operator.

6. The system of claim 1, wherein the at least one fatigue parameter of the operator is selected from eye blinks, heart beats, sitting posture with respect to a steering wheel and movement of head, hands and legs.

7. The system of claim 1, wherein the controller is configured to compare the at least one fatigue parameter with a threshold range, and configured to determine the fatigue condition of the operator based on the comparison of the at least one fatigue parameter with the threshold range.

8. The system of claim 1, wherein the controller is configured to generate the warning signal if a distance of the obstacle in the captured image of the surrounding area of the machine is within a threshold distance.

9. The system of claim 1, wherein the controller is configured to communicate the signal indicative of the action of the operator with the control module of the machine, if a response time required by the operator for taking action exceeds a threshold time.

10. A method of controlling operation of a machine, the method comprising:
determining a fatigue condition of an operator based on a signal indicative of at least one fatigue parameter received from a fatigue detection unit, via a controller;
detecting a presence of an obstacle in a surrounding area of the machine based on a captured image of the surrounding area of the machine via a proximity sensing unit;
generating a warning signal based on the fatigue condition of the operator and the captured image of the surrounding area of the machine via the controller;
monitoring an action of the operator in response to the generated warning signal; and
communicating a signal indicative of the action of the operator with a control module of the machine for autonomously controlling operation of the machine based on the signal indicative of the action of the operator.

11. The method of claim 10, wherein the autonomously controlling operation of the machine comprises at least one of terminating operation of the machine and shutting down an engine of the machine.

12. The method of claim 10 further comprising, communicating with a remote station for validating the fatigue condition of the operator via the controller.

13. The method of claim 10, wherein the at least one fatigue parameter of the operator is selected from eye blinks, heart beats, sitting posture with respect to a steering wheel and movement of head, hands and legs.

14. The method of claim 10 further comprising, comparing the at least one fatigue parameter with a threshold range, and determining the fatigue condition of the operator based on the comparison of the at least one fatigue parameter with the threshold range.

15. The method of claim 10 further comprising, generating the warning signal if a distance of the obstacle in the captured image of the surrounding area of the machine is within a threshold distance.

16. The method of claim 10 further comprising, communicating the signal indicative of the action of the operator with the control module of the machine via the controller, if a response time required by the operator for the taking action exceeds within a threshold time range.

17. A machine comprising:
a frame;
an operator cabin mounted on the frame of the machine;
a fatigue detection unit disposed within the operator cabin of the machine, the fatigue detection unit configured to generate a signal indicative of at least one fatigue parameter of an operator of the machine;
a proximity sensing unit disposed in the machine, the proximity sensing unit configured to capture image of a surrounding area of the machine; and
a controller communicatively coupled to the fatigue detection unit and the proximity sensing unit, the controller configured to:
determine a fatigue condition of the operator based on the signal indicative of the at least one fatigue parameter received from the fatigue detection unit;
detect a presence of an obstacle in the surrounding area of the machine based on the captured image of the surrounding area of the machine;
generate a warning signal based on the fatigue condition of the operator and the captured image of the surrounding area of the machine;
monitor action of the operator in response to the generated warning signal; and
communicate a signal indicative of the action of the operator with a control module of the machine, the control module configured to autonomously control operation of the machine based on the signal indicative of the action of the operator.

18. The machine of claim 17, wherein the controller is configured to compare at least one fatigue parameter with a threshold range, and configured to determine the fatigue condition of the operator based on the comparison of the at least one fatigue parameter with a threshold range.

19. The machine of claim 17, wherein the controller is configured to generate the warning signal if a distance of the obstacle in the captured image of the surrounding area of the machine is within a threshold distance.

20. The machine of claim 17, wherein the controller is configured to communicate the signal indicative of the action of the operator with the control module of the machine, if a response time required by the operator for taking action is exceeding a threshold time.
